(19) United States
(12) Patent Application Publication
(10) Pub. No.: US 2019/0279184 A1
(43) Pub. Date: Sep. 12, 2019

(54) TRANSACTION SYSTEM AND METHOD OF THE SAME

(71) Applicant: INNOGNITE LTD, London (GB)

(72) Inventor: Kay SELJESETH, Bærums Verk (NO)

(73) Assignee: INNOGNITE LTD, London (GB)

(21) Appl. No.: 16/345,478

(22) PCT Filed: Oct. 27, 2017
(86) PCT No.: PCT/NO2017/050277

§ 371 Date: Apr. 26, 2019

(30) Foreign Application Priority Data
Oct. 27, 2016 (NO) 20161698

(51) Int. Cl. G06Q 20/20; G06Q 20/32; G06Q 20/38; G06Q 20/40; G07D 11/23

(52) U.S. Cl. CPC G06Q 20/20; G06Q 20/3276; G07D 11/23; G06Q 20/385; G06Q 20/405; G06Q 20/3278

(57) ABSTRACT

The invention relates to a method and payment management system for removing change for cash transactions, comprising at least one point of sale, at least one financial service in electronical communication with the at least one point of sale, wherein the at least one point of sale is configured to receiving, from a customer, a payment of an amount exceeding a total amount due, acquiring a customer identity from the customer, processing the payment, the processing including calculating a surplus amount as the difference between the received payment and the total amount due, transferring the surplus amount to the at least one financial service over the electronical communication, and the at least one financial service is configured to transferring the surplus amount to the customer based on the customer identity.

### INTRODUCTION

The present invention relates to payment transactions and cash handling.

### BACKGROUND

In retail stores customers pay for articles at a manual or automated cash register in the store cash, credit card, debit cards or mobile phone payment systems. Traditionally, when the customers paid using cash, the cashier at the cash register would count the cash, enter the amount into the cash register, calculate the change and dispense change to the customer. The store manager would have to keep track of cash put into the cash register in the morning and repeat the process again in the evening when the cash was returned to a safe for storage. The store manager would also have to transport the cash to a bank for deposit, typically carrying the cash to a night safe. The manual cash handling involved risk of loss, theft, as well as personal injury in case of robbery. To alleviate some of these risks a large business of closed cash handlings systems and armored cash collection services has emerged. After the cash has reached the bank or cash handling provider, the cash undergoes cash processing where coins are sorted and stacked in coin rolls. The bank or cash handling provider sell the coin rolls back to the merchant with a surcharge, sometimes even surpassing the value of the coin roll. Cash, and in particular coin, management is a substantial cost for the stores.

### SUMMARY OF THE INVENTION

According to a first aspect, the invention provides a method of removing change from a cash transaction, the cash transaction including a point of sale receiving, from a customer, a payment of an amount exceeding a total amount due, comprising acquiring a customer identity from the customer, processing the payment, the processing including calculating a surplus amount as the difference between the received payment and the total amount due, and transferring the surplus amount electronically to the customer based on the customer identity. To achieve this customers need to identify them self using. Identification can be carried out using one of the following methods:
APP/Mobile device identification
Contactless like: RFID/NFC (may supplement APP)
Phone number/Email address (may supplement APP)
Finger print/Facial recognition/Iris recognition (may supplement APP)
Credit/Debit card
Merchant member/loyalty card
Chip and pin/Magnetic stripe (any card/device)

A checkout process according to the present invention where cash is used as a method for payment can at least comprise the steps of:
The customer places the purchased items on the checkout counter
The cashier registers the items into the Point of Sale (POS) system
When the registration is completed the cashier enters the POS payment stage
The cashier asks the customers about the preferred method of payment
The customer replies that (physical) cash is the desired means of payment
The cashier enters the amount paid or a cash recycler counts the amount and sends the total into the POS system
The Point of Sale system calculates the change due to be returned to the customer from the sales total and paid amount totals.
If there's a change due, then the POS system will ask the cashier (and optionally the customer) if the change due is to be paid as physical cash or be sent to the customers account directly.
The customer makes the decision to receive the exchange due into his account, and not to get physical cash in return
The cashier enter “Return to customer account” as the selected change method into the POS system
The POS system asks about the customer ID (methods as mentioned above)
The customer (or cashier) enters the identification using the mobile phone and/or a payment terminal. Other means may apply.
The POS system sends the electronic change to the customer account based on the identification
A plurality of payment gateways, payment processors and “behind the scene” systems may be involved to process the change transaction
The customer receives a standard paper receipt, or the receipt is sent electronically to the customer's account/profile
The customer may access and spend the change transferred from their own account directly (time may vary with payment systems involved)

According to a second aspect, the invention provides a payment management system for removing change from cash transactions, comprising at least one point of sale, at least one financial service in electronical communication with the at least one point of sale, where the at least one point of sale is configured to receiving, from a customer, a payment of an amount exceeding a total amount due, acquiring a customer identity from the customer, processing the payment, the processing including calculating a surplus amount as the difference between the received payment and the total amount due, transferring the surplus amount to the at least one financial service over the electronical communication, and the at least one financial service is configured to transferring the surplus amount to the customer based on the customer identity.

### BRIEF DESCRIPTION OF DRAWINGS

Embodiments of the invention will now be described with reference to the followings drawings, where:

FIG. 1 illustrates a payment management system.

FIG. 2 illustrates an exemplary payment management system according to an embodiment of the present invention.

FIG. 3 illustrates an exemplary signal flow according to an embodiment of the present invention.

### DETAILED DESCRIPTION

The present invention will be described with reference to the drawings.

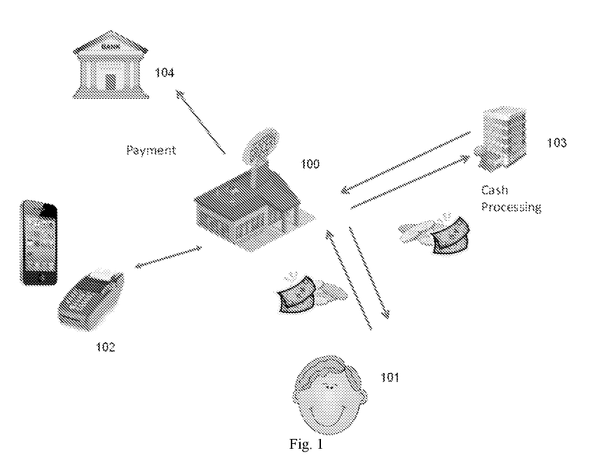

FIG. 1 illustrates a payment management system for a retail store 100. The store 100 is provided with an electronic payment terminal 102 that allows direct payment from a customer's bank account directly to a banking service 104 of the retail store. The electronic payment terminal may also include a mobile phone telephone system. Customer 101 is paying with cash, bills and/or coins, to a cashier at cash register in the retail store 100. The cashier counts the bills and/or coins, enters the amount into the cash register and calculates the change and dispenses the change to the customer. Counting the payment and dispensing the change may be done manually by the cashier or by using an automated counter/dispenser system, such as a closed cash handling system. Either way, the customer will receive coins from the cash register. The payment management system need to store sufficient amounts of coins to be able to deliver change to the customers of the store. Cash are regularly transmitted to a cash handling service 103 for cash processing. The cash are typically delivered by an employee or picked up by the cash handling service. The cash is counted and sorted, and the retail store 100 may receive a receipt of the deposited money that may be transferred to the banking service 104 of the retail store. The cash handling service sorts the coins according to value and stack them in coin rolls. The cash handling provider resells coin rolls to the retail store as per need with a surcharge. For smaller coins the surcharge sometimes even surpasses the value of the coins in the coin roll.

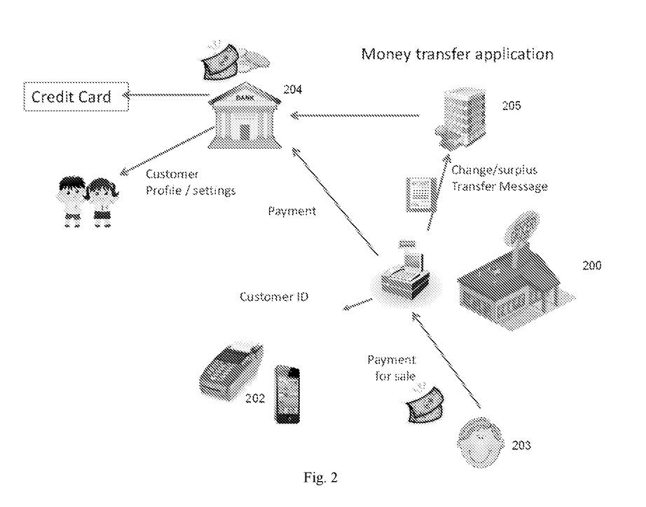

FIG. 2 illustrates a payment management system removing change from cash transactions for a retail store 200. The system comprises at least one point of sale, e.g. a cash register, 201, and at least one financial service 204, 205 in electronical communication with the at least one point of sale 201. A customer 203 is about to pay for items that has been registered at the at least on point of sale 201. The customer is informed about the total due to be paid, from watching a typical customer display or monitor and/or from the cashier telling the customer what the total amount due is. Based on the total due and/or preferences, the customer decides how to pay. In this case the customers selects to pay in such a way that a change amount normally should be returned to the customer, e.g. a payment of an amount exceeding a total amount due. When choosing the payment with change handling option the customer may inform the cashier about the choice verbally or provide the feedback in some other way to the system, via a button, touch screen or other input device. If the cashier is notified verbally, the cashier would input the payment choice into the point of sale system.

The at least one point of sale 201 is also configured to acquiring a customer identity from the customer 203. The customer identity is used to link the customer to the customer account or other monetary holding means that may be used. Such links may e.g. be registered and obtained from a database in the payment management system. The at least one point of sale 201 may further comprise an input device, such as a touch display or keyboard, to enable the cashier to input the customer identity to the point of sale 201. Such customer identity may be one of debit and credit card information, a bank account number, a short code, a phone number or a social security number. The at least one point of sale 201 may also comprises an electronic terminal 202 associated with the point of sale 201, where the electronic terminal 202 is configured to acquiring the customer identity from the customer by receiving an electronic ID. The electronic terminal 202 may be configured to receiving the electronic ID from a mobile device of the customer, and the electronic ID may be one of an integrated NFC mobile device identification, NFC or radio wave device identifications, MAC address information of mobile device, SIM card of mobile device. Alternatively, the electronic terminal 202 may be configured to receiving the electronic ID by reading a barcode, QR code, a magnetic stripe of a card or Chip-in-card information.

When the customer identity has been entered into the point of sale 201, the actual payment may be processed by receiving cash or other methods of payment from the customer. The payment may need to be verified and acknowledged if using a card based solution or similar payment method. The processing further includes calculating a surplus amount as the difference between the received payment and the total amount due. The surplus amount commonly known as change known from common point of sale business practice would have been returned to the customer as coins and bills totaling the change amount. Instead of returning physical money as mentioned, the at least one point of sale 201 transfers the surplus amount to the at least one financial service 204, 205 over the electronical communication using any applicable electronic message and/or signaling method. The at least one financial service 204, 205 is configured to transferring the surplus amount to the customer based on the customer identity. The at least one financial service 204, 205 is configured to based on the customer identity to transferring the surplus amount to other recipients based on customer preferences. Other recipients may include accounts that belong to other people, savings accounts, lottery style receivers or any small-amount payment recipient. The at least one point of sale 201 is configured to transferring the surplus amount electronically to the customer based on the customer identity by transmitting a change transfer message to the financial service 204, 205 to credit the surplus amount to the customer, transmitting an electronic receipt 206 to the financial service 204, 205, wherein the electronic receipt contains information to transfer the change to the customer as a part of an electronic receipt information system, or the point of sale system 201 displays or print a one-time code the customer use to redeem the surplus amount by using a mobile device to credit an account or other monetary holding target. The payment system also comprise an intermediate financial service 205 in communication with the at least one point of sale 201 and the at least one financial service 204, wherein the intermediate financial service is configured to receive the electronic receipt 206, and transmitting, based on the information to transfer the change to the customer, a change transfer message to the at least one financial service 204 to credit the surplus amount to the customer. The intermediate financial service 205 in communication with the at least one point of sale 201 and the at least one financial service 204 may also be configured to receiving the one-time code, and transmitting, based on the information of the one-time code, a change transfer message to the at least one financial service 204 to credit the surplus amount to the customer.

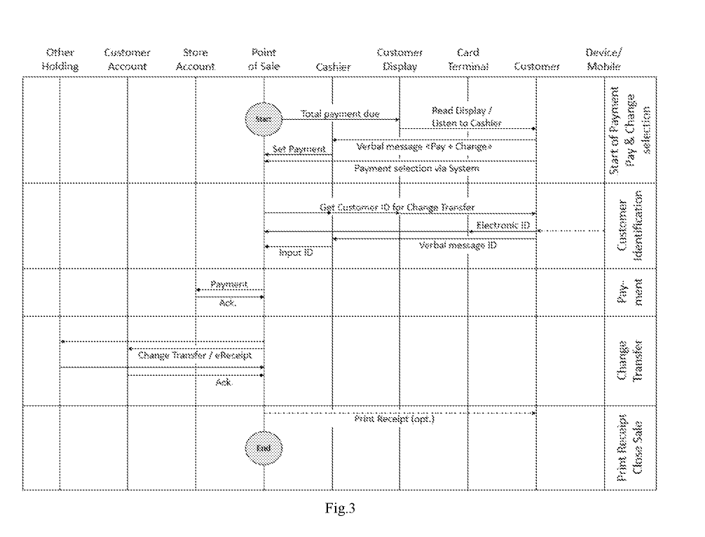

FIG. 3 illustrates an exemplary signal flow according to an embodiment of the present invention. At the start point, the items that are to be purchased have been already registered into the point of sale system and the customer payment is up next. Any coupons and other payable related credit and debit amount means would typically been processed before this step. In the steps Total payment due —Read Display/Listen to Cashier, the customer is informed about the total due to be paid, either from watching a customer display or monitor and/or from the cashier telling the customer what the total amount due is. From the total due and/or preferences of the customer, the customer decides how to pay. In this case the customers selects to pay in such a way that a change amount normally should be returned to the customer, e.g. a payment of an amount exceeding a total amount due. During Pay and change selection, the customer, when choosing a payment with change handling option, may inform the cashier about the choice verbally or provide the feedback in some other way to the system, via a button, touch screen or other input device. If the cashier is notified verbally, the cashier would input the payment choice into the point of sale system.

Choosing the payment with change handling option enables the point of sale system to continue processing by acquiring the customer identity in the Customer Identification step. The customer identity is used to link the customer to the customer account or other monetary holding means that may be used. Such links may e.g. be registered and obtained from a database in the payment management system. The point of sale is acquiring a customer identity from the customer. Acquiring the customer identity from the customer may comprise receiving an electronic ID at an electronic terminal associated with the point of sale. The electronic ID may be received from a mobile device of the customer, and the electronic ID may be one of an integrated NFC mobile device identification, NFC or radio wave device identifications, MAC address information of mobile device, SIM card of mobile device. Alternatively, the electronic ID may be received by reading a barcode, QR code, a magnetic stripe of a card or Chip-in-card information. Acquiring the customer identity from the customer may also comprise a cashier inputting the customer identity to the point of sale, i.e. on an input device associated with the point of sale, such as a touch display or keyboard. The customer identity may be one of debit and credit card information, a bank account number, a short code, a phone number or a social security number.

In the Payment step, when the required ID has been entered into the point of sale system, the actual payment may be processed by receiving cash or other methods of payment from the customer. The payment may need to be verified and acknowledged if using a card based solution or similar payment method. When processing the payment a surplus amount is calculated as the difference between the received payment and the total amount due.

In the Change Transfer step, the surplus amount is transferred electronically to the customer based on the customer identity. The surplus amount commonly known as change known from common point of sale business practice would have been returned to the customer as coins and bills totaling the change amount. Instead of returning physical money as mentioned the change is transferred to the customer by using an applicable electronic message and/or signaling method. The surplus amount may also be transferred to other recipients based on customer preferences. Other recipients may include accounts that belong to other people, savings accounts, lottery style receivers or any small-amount payment recipient. The electronically transfer of the surplus amount to the customer may be performed by transmitting a change transfer message to a financial service to credit the surplus amount to the customer, transmitting an electronic receipt to a financial service, wherein the electronic receipt contains information to transfer the change to the customer as a part of an electronic receipt information system, or the point of sale system displays or print a one-time code the customer use to redeem the surplus amount by using a mobile device to credit an account or other monetary holding target. Message and signaling systems used may send an acknowledgement back to the point of sale system to confirm a transaction. Means of encryption and authentication may be implemented to ensure the security of the transfer.

In the step Print Receipt, a paper or electronic receipt may be generated. The paper or electronic receipt may typically in clear text specify the change amount and the method of crediting the customer, together with the customer identification. When the receipt in the form of paper or an electronic data entity has been sent to the customer the sale and payment concludes.

In the following different transaction model steps are described, including those for credit cards, those from cell phones and merchant bank model.

Credit Card Transaction Model:
The POS system gets the input from the cashier (or consumer/customer) that a “no cash return transaction” is preferred by the customer, “No cash” transaction using a Credit card identity is to be used to transfer the change amount to the customer account
Optional:
   The POS system connects to the payment terminal and asks the terminal to read the consumer card identity details
   The consumer then swipes or inserts the card in the terminal (NFC may be used) and the payment terminal returns the customers id information (non PCI information)
   The POS system stores the consumer identity with the sales information for statistical/CRM related storage
The POS system connects to the payment terminal and requests the terminal to perform a deposit transaction to the card holder (consumer) account
   If the consumer has not already been identified during the optional stages this step is performed by reading the card details
The payment terminal processor will connect to the Credit card payment infrastructure and ask for the transaction to be completed
The Credit card system performs the back-end checking against the acquiring and issuing banks and completes the transaction if approved
The Credit card system confirms the transaction to the POS system/payment processor
The payment terminal confirms the same outcome to the POS system
The POS system confirms the transaction and completes the sale
The receipt will typically hold the transaction id number to document the change deposit.

Mobile Phone Payment Model:
The POS system gets the input from the cashier (or consumer/customer) that a NoCoin transaction using an Android phone is to be used to transfer the change amount to the consumer account
The POS system connects to the payment terminal and requests the terminal to perform a deposit transaction to the mobile phone owner's account
The consumer unlocks the phone and holds the phone over the payment terminal
The payment terminal processor connects to the Android Pay payment infrastructure and ask for the transaction to be completed
The Android Pay system performs the back-end checking against the acquiring and issuing banks and completes the transaction if approved
The Android Pay system confirms the transaction to the payment processor
The payment terminal confirms this to the POS system
Depending on merchant the consumer identity may be transferred to the POS system
The POS system confirms the transaction and completes the sale
The receipt will typically hold the transaction id number to document the change deposit

Merchant Bank Model:
Merchants having their own debit cards may transfer the NoCoin change directly to the account without involving external payment processors and external banks, as the merchants then act as both an issuing and acquiring bank.
The POS system gets the input from the cashier (or consumer/customer) that a NoCoin transaction using a the merchant own bank is to be used to transfer the change amount to the consumer account
The POS system connects to the payment terminal and requests the terminal to perform a deposit transaction to the card holder (consumer) account
The merchant bank system validates the transaction and completes the transaction if approved
The merchant own bank confirms the transaction to the POS system/payment processor
The payment terminal confirms this to the POS system
The POS system confirms the transaction and completes the sale
The receipt will typically hold the transaction id number to document the change deposit

Having described preferred embodiments of the invention it will be apparent to those skilled in the art that other embodiments incorporating the concepts may be used. These and other examples of the invention illustrated above are intended by way of example only and the actual scope of the invention is to be determined from the following claims.

1. Method of removing change from a cash transaction, the cash transaction including a point of sale receiving, from a customer, a payment of an amount exceeding a total amount due, the method comprising:
acquiring a customer identity from the customer;
processing the payment, the processing including calculating a surplus amount as the difference between the received payment and the total amount due; and
transferring the surplus amount electronically to the customer based on the customer identity.

2. Method according to claim 1, wherein the transferring the surplus amount electronically to the customer based on the customer identity further comprises one of:
transmitting a change transfer message to a financial service to credit the surplus amount to the customer;
transmitting an electronic receipt to a financial service, wherein the electronic receipt contains information to transfer the change to the customer as a part of an electronic receipt information system; and
the point of sale system displays or print a one-time code the customer use to redeem the surplus amount by using a mobile device to credit an account or other monetary holding target.

3. Method according to claim 1, wherein transferring the surplus amount electronically to the customer based on the customer identity further comprises transferring the surplus amount to other recipients based on customer preferences.

4. Method according to claim 1, wherein the acquiring a customer identity from the customer further comprises receiving an electronic ID at an electronic terminal associated with the point of sale.

5. Method according to claim 4, wherein the electronic ID is received from a mobile device of the customer, and the electronic ID is one of an integrated NFC mobile device identification, NFC or radio wave device identifications, MAC address information of mobile device, SIM card of mobile device.

6. Method according to claim 4, wherein the electronic ID is received by reading a barcode, QR code, a magnetic stripe of a card or Chip-in-card information.

7. Method according to claim 1, wherein the acquiring a customer identity from the customer further comprises a cashier inputting the customer identity to the point of sale.

8. Method according to claim 5, wherein the customer identity is one of debit and credit card information, a bank account number, a short code, a phone number or a social security number.

9. A payment management system for removing change from cash transactions, the system comprising
at least one point of sale;
at least one financial service in electronical communication with the at least one point of sale;
wherein the at least one point of sale is configured to
receiving, from a customer, a payment of an amount exceeding a total amount due;
acquiring a customer identity from the customer;
processing the payment, the processing including calculating a surplus amount as the difference between the received payment and the total amount due;
transferring the surplus amount to the at least one financial service over the electronical communication; and
the at least one financial service is configured to transferring the surplus amount to the customer based on the customer identity.

10. System according to claim 9, wherein the at least one point of sale the is further configured to transferring the surplus amount electronically to the customer based on the customer identity by one of:
transmitting a change transfer message to the financial service to credit the surplus amount to the customer;
transmitting an electronic receipt to the financial service, wherein the electronic receipt contains information to transfer the change to the customer as a part of an electronic receipt information system; and
the point of sale system displays or print a one-time code the customer use to redeem the surplus amount by using a mobile device to credit an account or other monetary holding target.

11. System according to claim 9, wherein the at least one financial service transferring the surplus amount to the customer based on the customer identity is further configured to transferring the surplus amount to other recipients based on customer preferences.

12. System according to claim 1, wherein the system further comprises an electronic terminal associated with the point of sale, the electronic terminal is configured to acquiring the customer identity from the customer by receiving an electronic ID.

13. System according to claim 12, wherein the electronic terminal is configured to receiving the electronic ID from a mobile device of the customer, and the electronic ID is one of an integrated NFC mobile device identification, NFC or radio wave device identifications, MAC address information of mobile device, SIM card of mobile device.

14. System according to claim 12, wherein the electronic terminal is configured to receiving the electronic ID by reading a barcode, QR code, a magnetic stripe of a card or Chip-in-card information.

15. System according to claim 9, wherein point of sale further comprises an input device configured to enable the cashier to input the customer identity to the point of sale.

16. System according to claim 15, wherein the customer identity is one of debit and credit card information, a bank account number, a short code, a phone number or a social security number.

17. System according to claim 10, wherein the system further comprises
an intermediate financial service in communication with the at least one point of sale and the at least one financial service, wherein the intermediate financial service is configured to
receive the electronic receipt;
transmitting, based on the information to transfer the change to the customer, a change transfer message to the at least one financial service to credit the surplus amount to the customer.

18. System according to claim 10, wherein the system further comprises
an intermediate financial service in communication with the at least one point of sale and the at least one financial service, wherein the intermediate financial service is configured to
receiving the one-time code;
transmitting, based on the information of the one-time code, a change transfer message to the at least one financial service to credit the surplus amount to the customer.
